(19) United States
(12) Patent Application Publication
(10) Pub. No.: US 2008/0210914 A1
(43) Pub. Date: Sep. 4, 2008

(54) Flame-retardant, curable moulding materials

(76) Inventors: Jan-Gerd Hansel, Bergisch Gladbach (DE); Otto Mauerer, Leichlingen (DE)

Correspondence Address: LANXESS CORPORATION, 111 RIDC PARK WEST DRIVE, PITTSBURGH, PA, 15275-1112, US

(21) Appl. No.: 11/974,332

(22) Filed: Oct. 12, 2007

(30) Foreign Application Priority Data
Oct. 20, 2006 (DE) 10 2006 049 519.5

(51) Int. Cl. C09K 21/12; C08K 5/52

(52) U.S. Cl. 252/609; 524/147

(57) ABSTRACT

The invention relates to a halogen-free flameproofing agent for curable moulding materials, the use of such flameproofing agents for the flame-retardant treatment of curable moulding materials, a process for the preparation of halogen-free, flame-retardant curable moulding materials, and halogen-free, flame-retardant curable moulding materials.

The invention relates to a halogen-free flameproofing agent for curable moulding materials, the use of such flameproofing materials for the flame-retardant treatment of curable moulding materials, a process for the preparation of halogen-free, flame-retardant curable moulding materials, and halogen-free, flame-retardant curable moulding materials.

### BACKGROUND OF THE INVENTION

Curable moulding materials based on unsaturated polyester resins, epoxy resins or polyurethanes are used for the production of coatings, semifinished products and components which may be reinforced with glass fibres. The cured products are distinguished by their good mechanical properties, their low density, substantial resistance to chemicals and their excellent surface quality. These properties and the advantageous price have led to them increasingly displacing the metallic materials in applications in the areas of railway vehicles, the building trade and aviation.

Depending on the respective field of use, curable moulding materials and the cured products which can be produced from them have to meet different requirements with regard to mechanical, electrical and fireproof properties.

The flameproof requirements of building materials, components and materials are extensive. Thus, for example, building materials and components may be classified according to DIN 4102, components for electrical equipment according to UL 94 or IEC-60695-2 and components for railway vehicles according to DIN 5510 and may be provided with an appropriate flame-retardant treatment for their use. Particular requirements are set, for example, for the treatment of aircraft (e.g. FAR 25.853) or ships (e.g. IMO A.652(16)). An overview of numerous tests and requirements is given, for example, by Jürgen Troitzsch, “Plastics Flammability Handbook”, 2004, Carl Hanser Verlag, Munich.

In addition, the fireproof requirements are constantly increasing. Thus, for example, new European standards which are intended to replace the existing national test standards set substantially higher flameproof requirements. Thus, the SBI test (EN 13823), for example, require not only the fire behaviour but also the smoke density be taken into account. The new standard (prEN 45545) proposed for railway vehicles takes into account, for example, fume density and fume toxicity. Requirements with regard to the fume toxicity, which is often determined by measurement of, inter alia, hydrogen halide concentrations in fume, may, for example, make the use of tried and tested halogen-containing flameproofing agents impossible. For many fields of use, this means that a tried and tested and functioning flameproofing treatment has to be revised to meet new requirements in line with standards.

It is known, for example, that unsaturated polyester resins can be made flame-retardant by using bromine- or chlorine-containing acids or alcohol components. Examples of these are hexachloroendomethylenetetrahydrophthalic acid (HET acid), tetrabromophthalic acid or dibromoneopentyl glycol. In the case of epoxy resins, flame retardance is achieved according to the prior art in general by incorporation of tetrabromobisphenol A as an alcohol component. Antimony trioxide is frequently used as synergistic agent. A disadvantage of such bromine- or chlorine-containing resins is that a fire results in the formation of corrosive gases which may lead to considerable damage to electron components, for example to relays. Another substantial disadvantage is that polychlorinated or polybrominated dibenzodioxins and dibenzofurans may form under unfavourable conditions. Antimony-containing additives are undesired for toxicological reasons.

There is therefore an increasing need for halogen-free and flame-retardant curable moulding materials which can then be processed to give flame-retardant end products.

The prior art, for example Becker/Braun, Kunststoff Handbuch Duroplaste [Plastics Handbook Thermosetting Plastics], Vol. 10, page 180, page 291, page 314 and page 326, Carl Hanser Verlag, Munich, Vienna, 1988, discloses that moulding materials comprising unsaturated polyester resins are treated with fillers, such as, for example, aluminium hydroxide. By elimination of water from the aluminium hydroxide at relatively high temperatures, a certain flame retardance is achieved thereby. In the case of very high filler contents of 150 to 400 parts of aluminium hydroxide per 100 parts of unsaturated polyester resin, self-extinguishing and a low fume density can then be achieved. The high specific gravity of the total material and the impairment of the mechanical properties are disadvantageous in the case of such systems. High filler contents also reduce the light transmittance of material. This is disadvantageous for some components, such as, for example, domelights. Owing to the high viscosity of such uncured, unsaturated polyester resins comprising aluminium hydroxide or magnesium hydroxide as a flameproofing agent, the processing is difficult if the resin is used for spraying or impregnation. Furthermore, the injection method cannot be employed with such formulations.

The abovementioned injection method is characterized in that glass fibre reinforcements are placed between two rigid mould halves and a cold-curable reaction material is injected into the cavity partly filled by the glass fibre reinforcement after the mould halves have been closed. Of course, a pumpable or flowable unsaturated polyester resin mixture (as reaction material) is required for this purpose.

Nowadays, textile glass mats comprising styrene-insoluble binders are predominantly used as reinforcing materials. Continuous mats and woven fabrics having different weights per unit area are also suitable.

In order to obtain halogen-free, flame-retardant unsaturated polyester resins having relatively low filler contents, the aluminium hydroxide can be partly or completely replaced by other flameproofing agents. U.S. Pat. No. 3,909,484 discloses the combination of aluminium hydroxide with alkyl phosphates. EP-A 0 308 699 describes the combination of aluminium hydroxide with ammonium polyphosphate. According to DE-A 2 159 757, mixtures of aluminium hydroxide with 1,3,5-triazine-2,4,6-triamine are suitable for the preparation of flame-retardant unsaturated polyester resins. Use of red phosphorus as a flameproofing agent for unsaturated polyester resins is known, for example from EP-A 0 848 035. The difficult processing of the spontaneously igniting red phosphorus, its tendency to form toxic phosphine and its intrinsic red colour are disadvantageous.

However, all abovementioned unsaturated polyester resins and the processes described for their preparation have the considerable disadvantage that they still have very high filler contents and therefore cannot be moulded to give the desired products by means of the industrially widely used injection methods. All combinations known to date of aluminium hydroxide with other flameproofing agents or other flameproofing system can be processed only with difficulty, if at all, by this method.

CA 2 334 274 proposes expandable graphite as a flameproofing agent for unsaturated polyester resins. Although the desired flame retardance can be achieved here with very low filler contents, this solution remains limited to special applications. The extremely large expanded graphite particles in comparison with the customary solid flameproofing agents complicate or prevent processing by the injection, spray or impregnation method. The black intrinsic colour of the expandable graphite is also disadvantageous.

WO 97/31056 describes the combination of 1,3,5-triazine-2,4,6-triamine with phosphorus-containing additives, e.g. ethylenediamine phosphate, as a flameproofing agent for halogen-free, unsaturated polyester resins. 15% by weight, based on total resin preparation, preferably 20% by weight, are mentioned as the lowest effective amount of 1,3,5-triazine-2,4,6-triamine. In the examples for WO 97/31056 the lowest amount of 1,3,5-triazine-2,4,6-triamine is 20% by weight.

EP-A 1 403 309 and EP-A 1 403 310 claim flame-retardant thermosetting plastic materials, for example based on unsaturated polyester resins or on epoxy resins, which contain a combination of phosphinic acid salts with synergistic agents as flameproofing agents. Phosphinic acid salts are distinguished by high thermal stability up to above 300° C. They are therefore used, for example, in the flame-retardant treatment of polyamide. The preparation of phosphinic acid salts requires a complicated, multistage synthesis which has to be carried out using particular safety measures owing to the handling of low-valent phosphorus compounds. The great technical effort associated therewith and the high costs cannot be justified for use in unsaturated polyester resins since particular thermal stability is not necessary. A curable moulding material according to EP-A 1 403 309 or EP-A 1 403 310 would therefore lose its abovementioned advantage of low costs.

It is therefore an object of the present invention to provide halogen-free and flame-retardant curable moulding materials which, on further processing to give end products, fulfil the flameproofing standards applicable in various areas, even in the case of a low filler content, in particular a filler content of less than 15% by weight based on the overall moulding material. In addition, the flame-retardant curable moulding materials should offer the possibility of further processing them by the spray, impregnation and injection method. The influences which arise out of the use of, in particular, solid flameproofing agents on the moulding materials and materials, such as, for example, increase in moulding material viscosity or deterioration in the mechanical properties of the cured moulding materials, should thus be kept as small as possible. Finally, it is an object of the invention to achieve said aims with the use of raw materials which are economical and technically simple to obtain.

### SUMMARY OF THE INVENTION

It was surprisingly found that halogen-free, flame-retardant curable moulding materials having extremely low filler contents can be prepared if a combination of ethylenediamine phosphate and at least two further additives is used as a flameproofing agent.

The invention relates to a halogen-free flameproofing agent for curable moulding materials, characterized in that it is a combination of ethylenediamine phosphate with at least one halogen-free phosphorus compound and at least one halogen-free nitrogen compound.

### DESCRIPTION OF THE PREFERRED EMBODIMENTS

The term “halogen-free” designates compounds in the molecules of which the atoms fluorine, chlorine, bromine and iodine are not present. The flameproofing agents according to the invention are preferably prepared from industrial raw materials. These industrial raw materials may contain halogen-containing impurities as a result of their preparation, but not more than 1000 ppm of halogen, based on the total flameproofing agent.

According to the invention, ethylenediamine phosphate is understood as meaning the neutralization product of ethylenediamine and orthophosphoric acid. It can be very easily prepared from the components as described, for example, in EP-A 0 104 350 and is commercially available.

Ethylenediamine phosphate having a particle size of 0.1 μm to 1000 μm, particularly preferably of 0.5 μm to 250 μm, is preferably used.

The halogen-free phosphorus compound is preferably a compound selected from the group consisting of phosphine oxides, esters or salts of organically substituted phosphinic acids, esters or salts of organically substituted phosphonic acids, esters or salts of phosphorous acid or esters or salts of ortho-, pyro- or polyphosphoric acid. The halogen-free phosphorus compound may have one, two or more phosphorus atoms per molecule.

The halogen-free phosphorus compound is preferably dimethyl methane phosphonate, diethyl ethane phosphonate, dimethyl propane phosphonate, dimethyl butane phosphonate, triethyl phosphate, tributyl phosphate, triisobutyl phosphate, triphenyl phosphate, diphenyl cresyl phosphate, tricresyl phosphate, mixtures of isopropylated aryl phosphates, mixtures of tert-butylated aryl phosphates, tetraphenyl resorcinol diphosphate or tetraphenyl bisphenol A diphosphate, the calcium, aluminium or zinc salt of diethyl phosphinic acid, of monomethyl methanephosphonate or of monomethyl propanephosphonate. It is also possible to use any desired mixtures of these substances. These substances can all be easily prepared by known processes and/or are commercially available.

The halogen-free phosphorus compound is preferably a liquid having a viscosity of less than 10 000 mPa.s at 20° C.; particularly preferably the viscosity is less than 1000 mPa.s at 20° C.

The halogen-free nitrogen compound is a compound selected from the group consisting of urea, urea cyanurate, guanidine, allantoin, glycouril, dicyandiamide, cyanuric acid or its derivatives, 1,3,5-triazine-2,4,6-triamine, isocyanuric acid or its derivatives, 1,3,5-triazine-2,4,6-triamine cyanurate, melem, melam, melon, ammonium phosphate, ammonium polyphosphate, 1,3,5-triazine-2,4,6-triamine phosphate and 1,3,5-triazine-2,4,6-triamine polyphosphate. These substances are all readily commercially available.

The halogen-free nitrogen compound is preferably 1,3,5-triazine-2,4,6-triamine.

The flameproofing agent according to the invention preferably contains 1 to 98 parts by mass of ethylenediamine phosphate, 1 to 98 parts by mass of halogen-free phosphorus compound and 1 to 98 parts by mass of halogen-free nitrogen compound per 100 parts by mass of flameproofing agent. In addition, the flameproofing agent may contain further substances, for example magnesium hydroxide, aluminium hydroxide or boric acid or its salts.

The invention also relates to the use of flameproofing agents containing ethylenediamine phosphate in combination with at least one halogen-free phosphorus compound and at least one halogen-free nitrogen compound for the flame-retardant treatment of curable moulding materials and the mouldings, laminates or coatings which can be produced from them by curing.

These mouldings, laminates or coatings are preferably reinforced by glass fibres.

The invention also relates to a process for the preparation of halogen-free and flame-retardant curable moulding materials, characterized in that the known raw materials for the preparation of curable moulding materials are mixed with a flameproofing agent consisting of a combination of ethylenediamine phosphate with at least one halogen-free phosphorus compound and at least one halogen-free nitrogen compound. The components of the flameproofing combination can be used individually or in the form of any desired mixtures.

In the process according to the invention, preferably 1 to 100 parts by mass of ethylenediamine phosphate, 1 to 20 parts by mass of halogen-free phosphorus compound and 1 to 50 parts by mass of halogen-free nitrogen compound are used per 100 parts by mass of curable moulding material.

Particularly preferably, 5 to 50 parts by mass of ethylenediamine phosphate, 1 to 10 parts by mass of halogen-free phosphorus compound and 5 to 30 parts by mass of halogen-free nitrogen compound are used per 100 parts by mass of curable moulding material.

The invention also relates to halogen-free, flame-retardant curable moulding materials, characterized in that they contain a combination of ethylenediamine phosphate with at least one halogen-free phosphorus compound and at least one halogen-free nitrogen compound as a flameproofing agent.

Preferably, the curable moulding materials contain 1 to 100 parts by mass of ethylenediamine phosphate, 1 to 20 parts by mass of halogen-free phosphorus compound and 1 to 50 parts by mass of halogen-free nitrogen compound per 100 parts by mass of curable moulding material.

Particularly preferably, the curable moulding materials contain 5 to 50 parts by mass of ethylenediamine phosphate, 1 to 10 parts by mass of halogen-free phosphorus compound and 5 to 30 parts by mass of halogen-free nitrogen compound per 100 parts by mass of curable moulding material.

In addition to said flameproofing agents, the moulding materials according to the invention may contain further constituents, such as pigments, stabilizers, inhibitors, reactive diluents, crosslinking agents, processing auxiliaries, lubricants, release compositions, demoulding compositions, electroconductive additives, glass fibres, carbon fibres, synthetic fibres or thickeners.

In a particularly preferred embodiment of the invention, the curable moulding materials are unsaturated polyester resins.

Unsaturated polyester resins are polycondensates of saturated and unsaturated dicarboxylic acids or anhydrides thereof with diols. The unsaturated polyester resins are cured by free radical polymerization with monomers such as styrene, methyl methacrylate, diallyl phthalate and similar vinyl compounds. The curing is controlled by initiators, such as, for example, peroxides, and accelerators. The double bonds in the polyester chain react with the double bond of the copolymerizable solvent monomer.

The most important dicarboxylic acids or anhydrides are maleic anhydride, fumaric acid, phthalic anhydride and terephthalic acid. The most frequently used diol is 1,2-propanediol. In addition, it is also possible to use ethylene glycol, diethylene glycol and neopentyl glycol. Styrene is most widely used as a monomer for crosslinking. It is infinitely miscible with the unsaturated polyester resins and can be readily polymerized, the styrene content of the unsaturated polyester resins usually being between 25 and 40% by weight.

Curable moulding materials based on unsaturated polyester resins are used in the construction industry for the production of lightweight boards, facade elements and swimming pools and as sealing materials, coatings and repair mortar; in general industry for the production of containers for beverages, heating oil, chemicals, fertilizers, foods and feeds and of chemical apparatuses, wastewater pipes and cooling towers; in the electrical industry for cable distribution and switch cabinets, light covers, multipoint connectors, switch covers and the like; in the transport sector for caravans and superstructures for refrigerated lorries, for the production of bumpers, freight containers, seat shells, etc; in boat and ship building for the construction of sport and rescue boats, fishing vehicles, life buoys and life rafts; for the production of a very wide range of shaped articles (apparatus housings, chairs, benches, traffic signs, head plates, etc).

In a further, particularly preferred embodiment of the invention, the curable moulding materials are epoxy resins.

Oligomeric compounds having more than one epoxide group per molecule are designated as epoxy resins. The conversion of the epoxy resins into thermosetting plastics is effected via polyaddition reactions with suitable curing agents, such as, for example, polyamines or dicyandiamides, or by polymerization via the epoxide groups. The predominant proportion of epoxy resins is prepared by reacting bisphenol A with epichlorohydrin in an alkaline medium with formation of oligomers having molar masses of 400-10 000 g/mol. Epoxy resins having a low molar mass of free-flowing to viscous, whereas those having a high molar mass are solid. Depending on the number of epoxide groups and hydroxyl groups per molecule, epoxy resins can be processed to give cold-curing two-component systems, stoving enamels or powder coats.

Curable moulding materials based on epoxy resins are used as casting resins in the electrical industry for the production of components for motors and insulators, in tool making, in the building trade for finishes, coatings and coverings, as well as adhesives for plastics, metals and concrete elements and as laminates for aircraft and vehicle construction. Epoxy resins are also used as exterior and interior coatings of tanks and containers for, for example, heating oils and fuels and are suitable as protective coatings of, for example, pipelines, fittings and devices and for coating floors and walls.

The invention is explained in more detail with reference to the following examples without there being any intention to limit the invention thereby.

### EXAMPLES

### Production of the Test Specimens

The test specimens were produced from the raw materials mentioned in Table 1, in the stated ratios. First, the liquid and solid flameproofing agents was stirred into the resin. All components were then thoroughly dispersed. Thereafter, peroxide and catalyst were stirred in in succession and dispersed. The now reactive mixtures was poured into moulds in which the material can cure. The temperatures of mixture and mould were chosen so that a sufficient pot life was available for handling but the resulting pot life was not so long that ingredients could settle out. After 24 hours, the moulds were postcured for 8 hours at 80° C. in an oven.

### Testing of the Fire Behaviour:

After demoulding, the test specimens were tested with regard to their fire behaviour according to UL 94 (standard test for flammability of plastics materials for parts and devices). For this purpose, the test specimens having dimensions of about 125×13×3.5 mm were clamped vertically in a holder and the flame of a small burner was applied twice in succession. If the sum of the after-burning times in a series of five test specimens from one formulation was less than 50 s, no test specimen continues to burn for more than 10 s after removal of the flame and no test specimen drips burning particles, the formulation was assigned to class V-0

The stated amounts of the formulation constituents in Table 1 are parts by weight, and the contents of flameproofing agents are stated as percent by weight, based on the total curable moulding material. All formulations mentioned therein achieved the class V-0 according to UL 94.
Formulations of Examples 1 and 2 and of comparative examples 3 to 7 not according to the invention (examples ordered according to increasing content of solid flameproofing agents)

TABLE 1

| | Examples | | | | | | |
|---|---|---|---|---|---|---|---|
| Formulation constituents | 1 | 2 | 3* | 4* | 5* | 6* | 7* |
| Orthophthalic acid resin | 80 | 80 | 75 | 75 | 75 | 70 | 60 |
| Ethylenediamine phosphate | 5 | 8 | | | | | |
| 1,3,5-Triazine-2,4,6-triamine | 4 | 5 | 15 | | | | |
| 1,3,5-Triazine-2,4,6-triamine cyanurate | | | | 15 | | | |
| AMPP** | | | | | 15 | | |
| Aluminium hydroxide | | | | | | 15 | 30 |
| Dimethyl propanephosphonate | 10 | 6 | 10 | 10 | 10 | 15 | 10 |
| MEK peroxide (curing agent) | 1 | 1 | 1 | 1 | 1 | 1 | 1 |
| Co(II) ethylhexanoate solution | 0.5 | 0.5 | 0.5 | 0.5 | 0.5 | 0.5 | 0.5 |
| (catalyst) | | | | | | | |
| Contents of flameproofing agent | | | | | | | |
| Total (% by weight) | 19 | 19 | 25 | 25 | 25 | 30 | 39 |
| Solid constituents (% by weight) | 9 | 13 | 15 | 15 | 15 | 15 | 30 |

*Comparative examples not according to the invention
**Aluminium monomethyl propanephosphonate

### Results

Table 1 shows the contents of flameproofing agent which are necessary for achieving the required flame retardance (Class V-0 according to UL 94). With the use of aluminium hydroxide, a reduction in the solids content can be achieved by increasing the proportion of the liquid phosphorus compound dimethyl propanephosphonate (Comparative Examples 6 and 7) but it is not possible to reduce the solids content below 15%. By replacing the aluminium hydroxide by the more effective flameproofing agent 1,3,5-triazine-2,4,6-triamine cyanurate or aluminium monomethyl propanephosphonate, it is possible to reduce the total contents of flameproofing agent, but the solids content cannot be reduced thereby (Comparative Examples 4 and 5). Even in the case of the combination of 1,3,5-triazine-2,4,6-triamine with a phosphorus compound, disclosed in WO97/31056, no improvement is observable (Comparative Example 3). This confirms that the amount of solid flameproofing agent cannot fall below the minimum amount of 15% mentioned in WO97/31056 without sacrificing the flame retardance.

Surprisingly, the combination of ethylenediamine phosphate with 1,3,5-triazine-2,4,6-triamine and dimethyl propanephosphonate shows particular effectiveness compared with all other formulations (Examples 1 and 2). The amount of solid flameproofing agents can be reduced below 15% in these cases, although here too the proportion of the liquid phosphorus compound is not higher than in the comparative examples.

Owing to their low solids content, the flameproofing agents according to the invention are particularly suitable if a low viscosity is required in the processing of curable moulding materials and good flame retardance, high mechanical values, a low density and a good light transmittance are required in the case of the cured resins. Since they are halogen-free, the disadvantages of halogen-containing moulding materials disclosed in the prior art are avoided. By using industrially readily available and economical raw materials, economic advantages of the curable moulding materials are retained.

What is claimed is:

1. A flameproofing agent for curable moulding materials, containing a combination of ethylenediamine phosphate and at least one halogen-free phosphorus compound and at least one halogen-free nitrogen compound.

2. A flameproofing agent according to claim 1, wherein the halogen-free phosphorus compound is dimethyl methanephosphonate, diethyl ethanephosphonate, dimethyl propanephosphonate, dimethyl butanephosphonate, triethyl phosphate, tributyl phosphate, triisobutyl phosphate, triphenyl phosphate, diphenyl cresyl phosphate, tricresyl phosphate, mixtures of isopropylated aryl phosphates, mixtures of tert-butylated aryl phosphates, tetraphenyl resorcinol diphosphate or tetraphenyl bisphenol A diphosphate, the calcium, aluminium or zinc salt of diethylphosphinic acid, of monomethyl methanephosphonate or of monomethyl propanephosphonate.

3. A flameproofing agent according to claim 1, wherein the halogen-free nitrogen compound is urea, urea cyanurate, guanidine, allantoin, glycouril, dicyandiamide, cyanuric acid or its derivates, 1,3,5-triazine-2,4,6-triamine, isocyanuric acid or its derivatives, 1,3,5-triazine-2,4,6-triamine cyanurate, melem, melam, melon, ammonium phosphate, ammonium polyphosphate, 1,3,5-triazine-2,4,6-triamine phosphate or 1,3,5-triazine-2,4,6-triamine polyphosphate.

4. A flameproofing agent according to claim 1, wherein the halogen-free phosphorus compound is dimethyl methanephosphonate, diethyl ethanephosphonate or dimethyl propanephosphonate and the halogen-free nitrogen compound is 1,3,5-triazine-2,4,6-triamine, 1,3,5-triazine-2,4,6-triamine phosphate, 1,3,5-triazine-2,4,6-triamine poly-phosphate or 1,3,5-triazine-2,4,6-triamine cyanurate.

5. A method of using flameproofing agents containing ethylenediamine phosphate and at least one halogen-free phosphorus compound and at least one halogen-free nitrogen compound for the flame-retardant treatment of curable moulding materials and the mouldings, laminates, or coatings which can be produced from them by curing.

6. A process for the preparation of halogen-free and flame-retardant curable moulding materials, wherein known raw materials for the preparation of curable moulding materials are mixed with a flameproofing agent consisting of a combination of ethylenediamine phosphate, at least one halogen-free phosphorus compound and at least one halogen-free nitrogen compound.

7. A halogen-free and flame-retardant curable moulding material, containing a combination of ethylenediamine phosphate, at least one halogen-free phosphorus compound and at least one halogen-free nitrogen compound as a flameproofing agent.

8. A material according to claim 7, wherein the moulding material is an unsaturated polyester resins.

9. A material according to claim 7, wherein the moulding material is an epoxy resins.

10. A moulding material according to claim 7, wherein the halogen-free phosphorus compound is dimethyl methanephosphonate, diethyl ethanephosphonate, or dimethyl propanephosphonate and the halogen-free nitrogen compound is 1,3,5-triazine-2,4,6-triamine, 1,3,5-triazine-2,4,6-triamine phosphate, 1,3,5-triazine-2,4,6-triamine poly-phosphate or 1,3,5-triazine-2,4,6-triamine isocyanurate.

11. A moulding material according to claim 7, containing 1 to 100 parts by mass of ethylenediamine phosphate, 1 to 20 parts by mass of the halogen-free phosphorus compound and 1 to 50 parts by mass of the halogen-free nitrogen compound per 100 parts by mass of moulding material.

12. A moulding material according to claim 7, containing 5 to 50 parts by mass of ethylenediamine phosphate, 1 to 10 parts by mass of the halogen-free phosphorus compound and 5 to 30 parts by mass of the halogen-free nitrogen compound per 100 parts by mass of moulding material.

13. Mouldings, laminates or coatings produced from a curable moulding material according to claim 7.

14. Mouldings, laminates or coatings according to claim 13, wherein glass fibres are used for reinforcement.
